(19) United States
(12) Patent Application Publication
(10) Pub. No.: US 2023/0320317 A1
(43) Pub. Date: Oct. 12, 2023

(54) PET HOUSE CONTROL METHOD AND SYSTEM, AND PET HOUSE

(71) Applicant: Clean Canine Inc, Cincinnati, OH (US)

(72) Inventor: Curt Olvey, Cincinnati, OH (US)

(21) Appl. No.: 18/023,290

(22) PCT Filed: Aug. 23, 2021
(86) PCT No.: PCT/CN2021/114142

§ 371 Date: Feb. 24, 2023

(30) Foreign Application Priority Data
Aug. 24, 2020 (CN) 202010859968.5

(51) Int. Cl. A01K 1/03; A01K 29/00

(52) U.S. Cl. CPC A01K 1/03; A01K 29/005

(57) ABSTRACT

The disclosure relates to the field of Internet of Things, and provides a pet house control method, a pet house control system and a pet house, so as to improve the intelligent level of control when the pet house is controlled. The method includes: receiving, through an Application (App) on the control terminal, settings of multiple operation modes of the pet house, the settings being set by a pet owner; computing, by a computing device built in the pet house, a current daily behavior of a pet, and transmitting a computing result back to the data center; triggering, by the data center, an operation mode Pconfi of the multiple operation modes if a condition set by the pet owner or the current daily behavior of the pet meets a trigger condition for the operation mode Pconfi; and performing, by the computing device related to the operation mode Pconfi, real-time control of the pet house according to a control strategy corresponding to the operation mode Pconfi. The technical scheme provided by the disclosure does not need or rarely needs the intervention of the pet owner, thus improving the intelligent level of the control of the pet house and saving the energy of the pet owner.

### TECHNICAL FIELD

The disclosure belongs to the field of Internet of Things (IoT), and in particular to, a pet house control method, a pet house control system and a pet house.

### BACKGROUND

Cats, dogs and other pets have always been loved by people, especially those who live alone in big cities, many of them keep pets as children, and the diet and daily life of these pets are also quite noted by these people, among which, the pet houses have been a focus continuously noted by pet owners recently. For pets, pet house is equivalent to a house for humans, and comfort is the first choice. Therefore, the focus for pet houses also lies in how to make pets live comfortably and make people who love pets spend less energy to take care of the pets and their pet houses.

An existing pet house is provided with build-in devices such as a camera and a temperature sensor, these devices are often connected to a smart terminal such as smart mobile phone. Thus, based on data transmitted by these devices to the smart terminal, a pet owner can observe the status of the pet house and the status of the pet living in the pet house, and control the pet house.

However, the above pet house or the control method of the pet house still lacks intelligence, for example, the real-time performance is not strong and the pet owner needs to make a judgment based on a current condition or historical experience, which obviously consumes more energy of the pet owner and cannot meet the needs of the pet owner.

### Technical Problem

The disclosure provides a pet house control method, a pet house control system and a pet house, so as to improve the intelligent level of control when the pet house is controlled.

### Technical Solution

A first aspect of the disclosure provides a pet house control method, the method including:
receiving, through an Application (App) on the control terminal, settings of multiple operation modes of the pet house, the settings being set by a pet owner;
computing, by a computing device built in the pet house, a current daily behavior of a pet, and transmitting a computing result back to the data center, wherein the computing device includes a timer and a far infrared instrument, wherein the far infrared instrument is provided with an audio and video device and at least one Universal Serial Bus (USB) port, and the audio and video device includes a motion sensor;
triggering, by the data center, an operation mode Pconfi of the multiple operation modes if a condition set by the pet owner or the current daily behavior of the pet meets a trigger condition for the operation mode Pconfi; and
performing, by the computing device related to the operation mode Pconfi, real-time control of the pet house according to a control strategy corresponding to the operation mode Pconfi.

According to some embodiments, the multiple operation modes include a saving mode, and computing, by the computing device built in the pet house, the current daily behavior of the pet and transmitting the computing result back to the data center includes:
detecting, by the audio and video device, the current daily behavior of the pet; and
if the audio and video device detects a static behavior of the pet, counting, by the timer, a duration of the static behavior of the pet and returning a counting result to the data center,
wherein triggering, by the data center, the operation mode Pconfi of the multiple operation modes if the condition set by the pet owner or the current daily behavior of the pet meets the trigger condition for the operation mode Pconfi includes: if the duration of the static behavior of the pet is within an earliest time period S of a preset duration range, triggering, by the data center, the saving mode; and
wherein performing, by the computing device related to the operation mode Pconfi, real-time control of the pet house according to the control strategy corresponding to the operation mode Pconfi includes: controlling, by the far infrared instrument related to the saving mode, the pet house to a temperature corresponding to the earliest time period S according to a temperature adjustment strategy corresponding to the saving mode.

According to some embodiments, the method further includes:
as the duration of the static behavior of the pet is within another time period S′ of the preset duration range, controlling, by the far infrared instrument, the pet house to a temperature corresponding to the another time period S′.

According to some embodiment, computing, by the computing device built in the pet house, the current daily behavior of the pet and transmitting the computing result back to the data center further includes: if the audio and video device detects a motion behavior of the pet, transmitting, by the audio and video device, a detection result back to the data center; and
wherein performing, by the computing device related to the operation mode Pconfi, real-time control of the pet house according to the control strategy corresponding to the operation mode Pconfi further includes: recovering, by the far infrared instrument related to the saving mode, the pet house to a comfort temperature from the temperature corresponding to the earliest time period S or the another time period S′ according to the temperature adjustment strategy corresponding to the saving mode.

According to some embodiments, the multiple operation modes include a vacation mode, and triggering, by the data center, the operation mode Pconfi of the multiple operation modes if the condition set by the pet owner or the current daily behavior of the pet meets the trigger condition for the operation mode Pconfi includes: if a time preset by the pet owner to start the vacation mode arrives or if the pet owner starts the vacation mode, triggering, by the data center, the vacation mode; and
wherein performing, by the computing device related to the operation mode Pconfi, real-time control of the pet house according to the control strategy corresponding to the operation mode Pconfi includes: pausing, by the far infrared instrument related to the vacation mode, heating of the pet house by the far infrared instrument according to a temperature adjustment strategy corresponding to the vacation mode.

According to some embodiments, the multiple operation modes include a treatment mode, and computing, by the computing device built in the pet house, the current daily behavior of the pet and transmitting the computing result back to the data center includes:
detecting, by the audio and video device, the current daily behavior of the pet; and
transmitting, by the audio and video device, the current daily behavior of the pet to the data center,
wherein triggering, by the data center, the operation mode Pconfi of the multiple operation modes if the condition set by the pet owner or the current daily behavior of the pet meets the trigger condition for the operation mode Pconfi includes: if the pet owner starts the treatment mode or if the current daily behavior of the pet meets a morbid physiological condition of the pet, triggering, by the data center, the treatment mode; and
wherein performing, by the computing device related to the operation mode Pconfi, real-time control of the pet house according to the control strategy corresponding to the operation mode Pconfi includes: performing, by the far infrared instrument related to the treatment mode, far infrared treatment on the pet in morbid state according to a treatment strategy corresponding to the treatment mode.

According to some embodiments, the multiple operation modes includes an extra comfort mode, and the infrared heater is further provided with a pressure sensing plate; and computing, by the computing device built in the pet house, the current daily behavior of the pet and transmitting the computing result back to the data center includes:
detecting, by the pressure sensing plate, whether the pet stays on the pressure sensing plate; and
if the pet stays on the pressure sensing plate, transmitting, by the pressure sensing plate or the audio and video device, data of the pet staying on the pressure sensing plate to the data center, wherein the data of the pet staying on the pressure sensing plate includes: a duration of the pet staying in the pet house, a duration of movement, a static state duration, and a frequency of entering and leaving the pet house,
wherein triggering, by the data center, the operation mode Pconfi of the multiple operation modes if the condition set by the pet owner or the current daily behavior of the pet meets the trigger condition for the operation mode Pconfi includes: if the pet owner starts the extra comfort mode or if the data of the pet staying on the pressure sensing plate meets a start condition of the extra comfort mode, triggering, by the data center, the extra comfort mode; and
wherein performing, by the computing device related to the operation mode Pconfi, real-time control of the pet house according to the control strategy corresponding to the operation mode Pconfi includes: performing, by the far infrared instrument related to the extra comfort mode, temperature control of the pet house and/or far infrared treatment on the pet according to a temperature adjustment strategy corresponding to the treatment mode.

According to some embodiments, the method further includes:
drawing, by the data center according to the data of the pet staying on the pressure sensing plate, a data curve indicating the daily behavior of the pet staying in the pet house; and
transmitting, by the data center, the data curve back to the App on the control terminal for display.

According to some embodiments, the method further includes:
acquiring, by the data center, data of the daily behavior of the pet through the App on the control terminal or the computing device; and
generating control strategies for real-time control of the pet house corresponding to the multiple operation modes by establishing a data model according to acquired data of the daily behavior.

According to some embodiments, the method further includes:
performing information interaction between the pet and the pet owner through the control terminal and the audio and video device.

A second aspect of the disclosure provides a pet house control system, including: a pet house, a control terminal, and a data center, wherein the pet house has a built-in computing device including a timer and a far infrared instrument, the far infrared instrument is provided with an audio and video device and at least one Universal Serial Bus (USB) port, and the audio and video device includes a motion sensor, and
wherein the control terminal is configured to receive, through an Application (App) on the control terminal, settings of multiple operation modes of the pet house, the settings being set by a pet owner;
the computing device is configured to compute a current daily behavior of the pet, and transmit a computing result to the data center;
the data center is configured to trigger an operation mode Pconfi of the multiple operation modes if a condition set by the pet owner or the current daily behavior of the pet meets a trigger condition for the operation mode Pconfi; and
the computing device related to the operation mode Pconfi is configured to perform real-time control of the pet house according to a control strategy corresponding to the operation mode Pconfi.

A third aspect of the disclosure provides a pet house control system, including a memory, a processor, and a computer program stored in the memory and executable on the processor, wherein when executing the compute program, the processor performs operations of:
receiving, through an Application (App) on the control terminal, settings of multiple operation modes of the pet house, the settings being set by a pet owner;
computing, by a computing device built in the pet house, a current daily behavior of a pet, and transmitting a computing result back to the data center, wherein the computing device includes a timer and a far infrared instrument, wherein the far infrared instrument is provided with an audio and video device and at least one Universal Serial Bus (USB) port, and the audio and video device includes a motion sensor;
triggering, by the data center, an operation mode Pconfi of the multiple operation modes if a condition set by the pet owner or the current daily behavior of the pet meets a trigger condition for the operation mode Pconfi; and
performing, by the computing device related to the operation mode Pconfi, real-time control of the pet house according to a control strategy corresponding to the operation mode Pconfi.

According to some embodiments, the multiple operation modes include a saving mode, and computing, by the computing device built in the pet house, the current daily behavior of the pet and transmitting the computing result back to the data center includes:
detecting, by the audio and video device, the current daily behavior of the pet; and
if the audio and video device detects a static behavior of the pet, counting, by the timer, a duration of the static behavior of the pet and returning a counting result to the data center,
wherein triggering, by the data center, the operation mode Pconfi of the multiple operation modes if the condition set by the pet owner or the current daily behavior of the pet meets the trigger condition for the operation mode Pconfi includes: if the duration of the static behavior of the pet is within an earliest time period S of a preset duration range, triggering, by the data center, the saving mode; and
wherein performing, by the computing device related to the operation mode Pconfi, real-time control of the pet house according to the control strategy corresponding to the operation mode Pconfi includes: controlling, by the far infrared instrument related to the saving mode, the pet house to a temperature corresponding to the earliest time period S according to a temperature adjustment strategy corresponding to the saving mode.

According to some embodiments, the method further includes:
as the duration of the static behavior of the pet is within another time period S′ of the preset duration range, controlling, by the far infrared instrument, the pet house to a temperature corresponding to the another time period S′.

According to some embodiment, computing, by the computing device built in the pet house, the current daily behavior of the pet and transmitting the computing result back to the data center further includes: if the audio and video device detects a motion behavior of the pet, transmitting, by the audio and video device, a detection result back to the data center; and
wherein performing, by the computing device related to the operation mode Pconfi, real-time control of the pet house according to the control strategy corresponding to the operation mode Pconfi further includes: recovering, by the far infrared instrument related to the saving mode, the pet house to a comfort temperature from the temperature corresponding to the earliest time period S or the another time period S′ according to the temperature adjustment strategy corresponding to the saving mode.

According to some embodiments, the multiple operation modes include a vacation mode, and triggering, by the data center, the operation mode Pconfi of the multiple operation modes if the condition set by the pet owner or the current daily behavior of the pet meets the trigger condition for the operation mode Pconfi includes: if a time preset by the pet owner to start the vacation mode arrives or if the pet owner starts the vacation mode, triggering, by the data center, the vacation mode; and
wherein performing, by the computing device related to the operation mode Pconfi, real-time control of the pet house according to the control strategy corresponding to the operation mode Pconfi includes: pausing, by the far infrared instrument related to the vacation mode, heating of the pet house by the far infrared instrument according to a temperature adjustment strategy corresponding to the vacation mode.

According to some embodiments, the multiple operation modes include a treatment mode, and computing, by the computing device built in the pet house, the current daily behavior of the pet and transmitting the computing result back to the data center includes:
detecting, by the audio and video device, the current daily behavior of the pet; and
transmitting, by the audio and video device, the current daily behavior of the pet to the data center,
wherein triggering, by the data center, the operation mode Pconfi of the multiple operation modes if the condition set by the pet owner or the current daily behavior of the pet meets the trigger condition for the operation mode Pconfi includes: if the pet owner starts the treatment mode or if the current daily behavior of the pet meets a morbid physiological condition of the pet, triggering, by the data center, the treatment mode; and
wherein performing, by the computing device related to the operation mode Pconfi, real-time control of the pet house according to the control strategy corresponding to the operation mode Pconfi includes: performing, by the far infrared instrument related to the treatment mode, far infrared treatment on the pet in morbid state according to a treatment strategy corresponding to the treatment mode.

According to some embodiments, the multiple operation modes includes an extra comfort mode, and the infrared heater is further provided with a pressure sensing plate; and computing, by the computing device built in the pet house, the current daily behavior of the pet and transmitting the computing result back to the data center includes:
detecting, by the pressure sensing plate, whether the pet stays on the pressure sensing plate; and
if the pet stays on the pressure sensing plate, transmitting, by the pressure sensing plate or the audio and video device, data of the pet staying on the pressure sensing plate to the data center, wherein the data of the pet staying on the pressure sensing plate includes: a duration of the pet staying in the pet house, a duration of movement, a static state duration, and a frequency of entering and leaving the pet house,
wherein triggering, by the data center, the operation mode Pconfi of the multiple operation modes if the condition set by the pet owner or the current daily behavior of the pet meets the trigger condition for the operation mode Pconfi includes: if the pet owner starts the extra comfort mode or if the data of the pet staying on the pressure sensing plate meets a start condition of the extra comfort mode, triggering, by the data center, the extra comfort mode; and
wherein performing, by the computing device related to the operation mode Pconfi, real-time control of the pet house according to the control strategy corresponding to the operation mode Pconfi includes: performing, by the far infrared instrument related to the extra comfort mode, temperature control of the pet house and/or far infrared treatment on the pet according to a temperature adjustment strategy corresponding to the treatment mode.

According to some embodiments, the method further includes:
drawing, by the data center according to the data of the pet staying on the pressure sensing plate, a data curve indicating the daily behavior of the pet staying in the pet house; and
transmitting, by the data center, the data curve back to the App on the control terminal for display.

According to some embodiments, the method further includes:
acquiring, by the data center, data of the daily behavior of the pet through the App on the control terminal or the computing device; and
generating control strategies for real-time control of the pet house corresponding to the multiple operation modes by establishing a data model according to acquired data of the daily behavior.

According to some embodiments, the method further includes:
performing information interaction between the pet and the pet owner through the control terminal and the audio and video device.

A second aspect of the disclosure provides a pet house control system, including: a pet house, a control terminal, and a data center, wherein the pet house has a built-in computing device including a timer and a far infrared instrument, the far infrared instrument is provided with an audio and video device and at least one Universal Serial Bus (USB) port, and the audio and video device includes a motion sensor, and
wherein the control terminal is configured to receive, through an Application (App) on the control terminal, settings of multiple operation modes of the pet house, the settings being set by a pet owner;

the computing device is configured to compute a current daily behavior of the pet, and transmit a computing result to the data center;
the data center is configured to trigger an operation mode Pconfi of the multiple operation modes if a condition set by the pet owner or the current daily behavior of the pet meets a trigger condition for the operation mode Pconfi; and
the computing device related to the operation mode Pconfi is configured to perform real-time control of the pet house according to a control strategy corresponding to the operation mode Pconfi.

A fourth aspect of the disclosure provides a computer-readable storage medium having stored thereon computer program instructions that, when executed by a processor, cause the processor to perform operations of:
receiving, through an Application (App) on the control terminal, settings of multiple operation modes of the pet house, the settings being set by a pet owner;
computing, by a computing device built in the pet house, a current daily behavior of a pet, and transmitting a computing result back to the data center, wherein the computing device includes a timer and a far infrared instrument, wherein the far infrared instrument is provided with an audio and video device and at least one Universal Serial Bus (USB) port, and the audio and video device includes a motion sensor;
triggering, by the data center, an operation mode Pconfi of the multiple operation modes if a condition set by the pet owner or the current daily behavior of the pet meets a trigger condition for the operation mode Pconfi; and
performing, by the computing device related to the operation mode Pconfi, real-time control of the pet house according to a control strategy corresponding to the operation mode Pconfi.

According to some embodiments, the multiple operation modes include a saving mode, and computing, by the computing device built in the pet house, the current daily behavior of the pet and transmitting the computing result back to the data center includes:
detecting, by the audio and video device, the current daily behavior of the pet; and
if the audio and video device detects a static behavior of the pet, counting, by the timer, a duration of the static behavior of the pet and returning a counting result to the data center,
wherein triggering, by the data center, the operation mode Pconfi of the multiple operation modes if the condition set by the pet owner or the current daily behavior of the pet meets the trigger condition for the operation mode Pconfi includes: if the duration of the static behavior of the pet is within an earliest time period S of a preset duration range, triggering, by the data center, the saving mode; and
wherein performing, by the computing device related to the operation mode Pconfi, real-time control of the pet house according to the control strategy corresponding to the operation mode Pconfi includes: controlling, by the far infrared instrument related to the saving mode, the pet house to a temperature corresponding to the earliest time period S according to a temperature adjustment strategy corresponding to the saving mode.

According to some embodiments, the method further includes:

The infrared heater controls the pet house to a temperature corresponding to the other time period S′ as the time period of the pet'S static behavior is in the preset time range.

According to some embodiment, computing, by the computing device built in the pet house, the current daily behavior of the pet and transmitting the computing result back to the data center further includes: if the audio and video device detects a motion behavior of the pet, transmitting, by the audio and video device, a detection result back to the data center; and
wherein performing, by the computing device related to the operation mode Pconfi, real-time control of the pet house according to the control strategy corresponding to the operation mode Pconfi further includes: recovering, by the far infrared instrument related to the saving mode, the pet house to a comfort temperature from the temperature corresponding to the earliest time period S or the another time period S′ according to the temperature adjustment strategy corresponding to the saving mode.

According to some embodiments, the multiple operation modes include a vacation mode, and triggering, by the data center, the operation mode Pconfi of the multiple operation modes if the condition set by the pet owner or the current daily behavior of the pet meets the trigger condition for the operation mode Pconfi includes: if a time preset by the pet owner to start the vacation mode arrives or if the pet owner starts the vacation mode, triggering, by the data center, the vacation mode; and
wherein performing, by the computing device related to the operation mode Pconfi, real-time control of the pet house according to the control strategy corresponding to the operation mode Pconfi includes: pausing, by the far infrared instrument related to the vacation mode, heating of the pet house by the far infrared instrument according to a temperature adjustment strategy corresponding to the vacation mode.

According to some embodiments, the multiple operation modes include a treatment mode, and computing, by the computing device built in the pet house, the current daily behavior of the pet and transmitting the computing result back to the data center includes:
detecting, by the audio and video device, the current daily behavior of the pet; and
transmitting, by the audio and video device, the current daily behavior of the pet to the data center,
wherein triggering, by the data center, the operation mode Pconfi of the multiple operation modes if the condition set by the pet owner or the current daily behavior of the pet meets the trigger condition for the operation mode Pconfi includes: if the pet owner starts the treatment mode or if the current daily behavior of the pet meets a morbid physiological condition of the pet, triggering, by the data center, the treatment mode; and
wherein performing, by the computing device related to the operation mode Pconfi, real-time control of the pet house according to the control strategy corresponding to the operation mode Pconfi includes: performing, by the far infrared instrument related to the treatment mode, far infrared treatment on the pet in morbid state according to a treatment strategy corresponding to the treatment mode.

According to some embodiments, the multiple operation modes includes an extra comfort mode, and the infrared heater is further provided with a pressure sensing plate; and computing, by the computing device built in the pet house, the current daily behavior of the pet and transmitting the computing result back to the data center includes:
detecting, by the pressure sensing plate, whether the pet stays on the pressure sensing plate; and
if the pet stays on the pressure sensing plate, transmitting, by the pressure sensing plate or the audio and video device, data of the pet staying on the pressure sensing plate to the data center, wherein the data of the pet staying on the pressure sensing plate includes: a duration of the pet staying in the pet house, a duration of movement, a static state duration, and a frequency of entering and leaving the pet house,
wherein triggering, by the data center, the operation mode Pconfi of the multiple operation modes if the condition set by the pet owner or the current daily behavior of the pet meets the trigger condition for the operation mode Pconfi includes: if the pet owner starts the extra comfort mode or if the data of the pet staying on the pressure sensing plate meets a start condition of the extra comfort mode, triggering, by the data center, the extra comfort mode; and
wherein performing, by the computing device related to the operation mode Pconfi, real-time control of the pet house according to the control strategy corresponding to the operation mode Pconfi includes: performing, by the far infrared instrument related to the extra comfort mode, temperature control of the pet house and/or far infrared treatment on the pet according to a temperature adjustment strategy corresponding to the treatment mode.

According to some embodiments, the method further includes:
drawing, by the data center according to the data of the pet staying on the pressure sensing plate, a data curve indicating the daily behavior of the pet staying in the pet house; and
transmitting, by the data center, the data curve back to the App on the control terminal for display.

According to some embodiments, the method further includes:
acquiring, by the data center, data of the daily behavior of the pet through the App on the control terminal or the computing device; and
generating control strategies for real-time control of the pet house corresponding to the multiple operation modes by establishing a data model according to acquired data of the daily behavior.

According to some embodiments, the method further includes:
performing information interaction between the pet and the pet owner through the control terminal and the audio and video device.

A fifth aspect of the disclosure further provides a pet house, including: a pet house body, and a computing device in the pet house control method above, and the pet house is controlled using the pet house control method which includes:
receiving, through an Application (App) on the control terminal, settings of multiple operation modes of the pet house, the settings being set by a pet owner;
computing, by a computing device built in the pet house, a current daily behavior of a pet, and transmitting a computing result back to the data center, wherein the computing device includes a timer and a far infrared instrument, wherein the far infrared instrument is provided with an audio and video device and at least one Universal Serial Bus (USB) port, and the audio and video device includes a motion sensor;
triggering, by the data center, an operation mode Pconfi of the multiple operation modes if a condition set by the pet owner or the current daily behavior of the pet meets a trigger condition for the operation mode Pconfi; and
performing, by the computing device related to the operation mode Pconfi, real-time control of the pet house according to a control strategy corresponding to the operation mode Pconfi.

### Beneficial Effects

According to the technical scheme provided by the disclosure, on one hand, the pet owner can set various operation modes of the pet house at any time and anywhere, the data center can control the pet house in real time, and the control manner of the pet house in the disclosure has enhanced real-time performance, so that the problems of the pet house and the pet can be found in time; on the other hand, the computing device built in the pet house computes the current daily behavior of the pet and transmits the computing result back to the data center, and then the data center triggers one operation mode Pconfi of the set operation modes, and the computing device related to the operation mode Pconfi performs real-time control of pet house according to the control strategy corresponding to the operation mode Pconfi, which not only improves the automation level of pet house control, but also significantly improves the intelligent level of pet house control because the control strategy can be obtained by machine learning; furthermore, the technical scheme provided by the disclosure can be precisely controlled by a computer program without or with little need for intervention by the pet owner, thereby saving the energy of the pet owner.

### BRIEF DESCRIPTION OF DRAWINGS

In order to more clearly explain the specific embodiments of the disclosure or the technical scheme in the prior art, the drawings required for use in particular the description of the embodiments or prior art will be briefly described below, and it will be apparent that the drawings in the following description correspond to some embodiments of the disclosure from which other drawings may be obtained without creative effort by a person of ordinary skill in the art.

FIG. 1 is a schematic flowchart of a pet house control method provided by an embodiment of the disclosure;

FIG. 2 is a schematic flowchart of a pet house control method provided by another embodiment of the disclosure;

FIG. 3 is a schematic flowchart of a pet house control method provided by another embodiment of the disclosure;

FIG. 4 is a schematic flowchart of a pet house control method provided by another embodiment of the disclosure;

FIG. 5 is a schematic flowchart of a pet house control method provided by another embodiment of the disclosure;

FIG. 6 is a schematic structural diagram of a pet house control system provided by an embodiment of the disclosure; and

FIG. 6 is a schematic structural diagram of a pet house control system provided by another embodiment of the disclosure.

### DETAILED DESCRIPTION

A clear and complete description of the technical aspects of the disclosure will be given below in conjunction with the accompanying drawings, and it will be apparent that the described embodiments are part of and not all of the embodiments of the disclosure. Based on the embodiments in the disclosure, all other embodiments obtained by those of ordinary skill in the art without making creative efforts fall within the scope of protection of the disclosure.

In the description of the disclosure, it should be noted that, the terms “center”, “up”, “down”, “left”, “right”, “vertical”, “horizontal”, “inside”, “outside” and the like indicate an orientation or positional relationship based on those shown in the drawings, they are intended for ease of description and simplification of the description only, but are not intended to indicate or imply that the device or element in question must have a particular orientation, must be constructed and operate in a particular orientation; and therefore these terms cannot be construed as limiting the disclosure. In addition, the terms “first”, “second”, “third” and the like are used for descriptive purposes only and cannot be understood as indicating or implying relative importance.

In the description of the disclosure, unless otherwise expressly specified and limited, it should be noted that the terms “mount”, “connect with” and “connected to” are understood in a broad sense. For example, they may refer to fixed connection, detachable connection or integral connection; they may refer to mechanical connection or electrical connection; they may refer to direct connection, or indirect connection through an intermediate medium, or internal communication within two components, which can be wireless or wired. The specific meanings of the above terms in the disclosure may be understood by those of ordinary skill in the art according to specific conditions.

Furthermore, the technical features described below in various embodiments of the disclosure may be combined with each other as long as they do not conflict with each other.

In order to explain the technical scheme of the disclosure, specific embodiments will be described below.

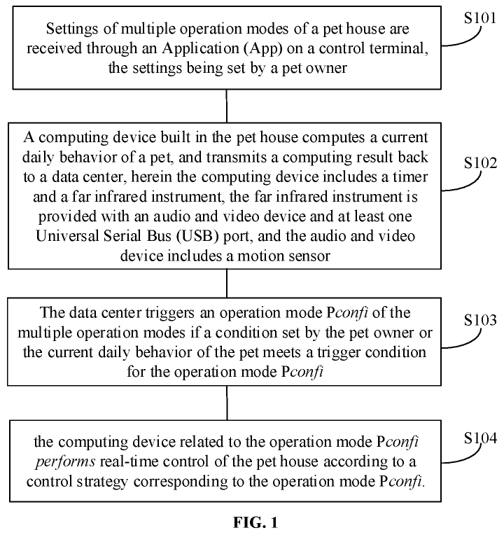

FIG. 1 is a schematic flowchart of a pet house control method provided by an embodiment of the disclosure. The method includes operations S101 to S104 specifically described as follows.

In S101, settings of multiple operation modes of a pet house are received through an Application (App) on a control terminal, the settings being set by a pet owner.

In the embodiment of the disclosure, the control terminal may be a computing device, such as a personal computer, a mobile phone or a smart mobile phone. Apps in these control terminals, for example, an App in a smart phone, can provide a User Interface (UI). Through each of these UIs, a pet owner sets various operation modes of a pet house, such as setting temperature in a certain operation mode, setting a duration for a certain state (for example, static state) of the pet, setting a duration for implementing a certain treatment plan for the pet, and setting a duration for maintaining a certain temperature in the pet house. These setting information can be input in a UI provided by the control terminal.

In S102, a computing device built in the pet house computes a current daily behavior of a pet, and transmits a computing result back to a data center, herein the computing device includes a timer and a far infrared instrument, the far infrared instrument is provided with an audio and video device and at least one Universal Serial Bus (USB) port, and the audio and video device includes a motion sensor.

In the embodiment of the disclosure, the far infrared instrument has a wireless communication module to connect with the data center through a network. The audio and video device includes an audio device, a video device and a motion sensor. Herein, the audio device can be a telephone device capable of two-way communication, and the video device includes a video player. The audio device is responsible for acquiring the sound data in the pet house, and transmitting the sound to the data center. The motion sensor is responsible for acquiring image data in the pet house, and transmitting the image data to the data center. The data center can be a high-performance server or server array, it is connected with the control terminal and the computing device built in the pet house through a network, and transmits various data between the data center and the control terminal and between the data center and the computing device built in the pet house. The various data include parameters, control instructions, audio, image and video and the like. The computing result of the current daily behavior of the pet computed by the computing device may include a parameter, an audio, an image or a video. For example, the parameter may be a movement duration or duration of static state of the pet, and the audio may be sound made by the pet or sound made by the pet owner calling for the pet or the like.

It should be noted that at least one USB port arranged in the far infrared instrument is mainly used for connecting some accessory electronic devices, such as a camera with a USB port, a pressure sensing plate or even an electronic feeder mentioned in subsequent embodiments. These accessory electronic devices are connected with the far infrared instrument through the USB port, and then communicate with the data center through the far infrared instrument. These accessory electronic devices are controlled by the pet owner through the control terminal, for example, by an App on a smart phone. The working mechanism is that a USB-female of the USB port of the far infrared instrument is connected with a USB-male at one end of a USB wire, a USB-male at the other end of the USB wire (or data line) is connected to a USB-female of another USB port, which is connected to a power supply or a data source of another device. In this way, the far infrared instrument is powered by the power supply through the USB wire, or data is exchanged between the far infrared instrument and another device (e.g., an accessory electronic device) through a USB data line. Not only the far infrared instrument has the USB port and the working mechanism above, other computing devices built in the pet house in the embodiments of the disclosure, such as a pressure sensing plate of an infrared heating mat, an electronic feeder, a smart mobile phone, a digital camera, a digital speaker, a microphone, an electric fan, an air freshener and a drinking water system, also have the same USB port and corresponding working mechanism as the far infrared instrument, which will not be described repeatedly herein.

In S103, the data center triggers an operation mode Pconfi of the multiple operation modes if a condition set by the pet owner or the current daily behavior of the pet meets a trigger condition for the operation mode Pconfi.

In the embodiment of the disclosure, the trigger condition of one operation mode Pconfi of the operation modes can be a condition set by the pet owner, it can also be that the current daily behavior of the pet reaches a certain value. Herein, the condition set by the pet owner can be transmitted to the data center by the App of the control terminal; and as mentioned above, the current daily behavior of the pet is computed by the computing device built in the pet house and transmitted back to the data center by the computing device. As long as the condition set by the pet owner or the current daily behavior of the pet meets the trigger condition of the operation mode Pconfi, the data center triggers the operation mode Pconfi in a trigger manner that a network is used to transmit a control instruction to the computing device related to the operation mode Pconfi.

In S104, the computing device related to the operation mode Pconfi performs real-time control of the pet house according to a control strategy corresponding to the operation mode Pconfi.

As mentioned above, the trigger manner for the data center to trigger the operation mode Pconfi is that the control instruction is transmitted by the data center to the computing device related to the operation mode Pconfi by using the network. As a compositional part of the control strategy, after the control instruction is issued from the data center to the computing device related to the operation mode Pconfi, the computing device follows the control strategy corresponding to the operation mode Pconfi to perform real-time control of the pet house, for example, increasing the heating temperature of the far infrared instrument, treating the pet by the far infrared instrument, or the like.

As can be seen from the pet house control method of the above example in FIG. 1, on one hand, the pet owner can set various operation modes of the pet house at any time and anywhere, the data center can control the pet house in real time, and the control manner of the pet house in the disclosure has enhanced real-time performance, so that the problems of the pet house and the pet can be found in time; on the other hand, the computing device built in the pet house computes the current daily behavior of the pet and transmits the computing result back to the data center, and then the data center triggers one operation mode Pconfi of the set operation modes, and the computing device related to the operation mode Pconfi performs real-time control of pet house according to the control strategy corresponding to the operation mode Pconfi, which not only improves the automation level of pet house control, but also significantly improves the intelligent level of pet house control because the control strategy can be obtained by machine learning; furthermore, the technical scheme provided by the disclosure can be precisely controlled by a computer program without or with little need for intervention by the pet owner, thereby saving the energy of the pet owner.

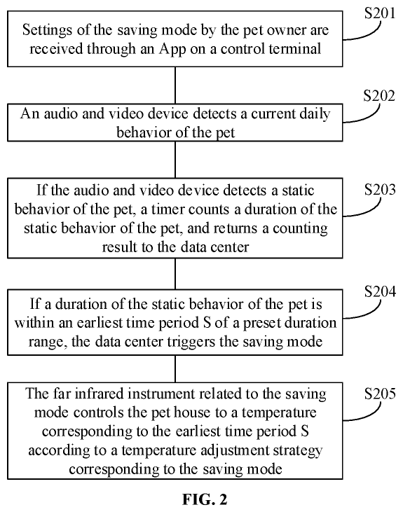

Referring to FIG. 2, which is a schematic flowchart of a pet house control method when a saving mode is taken as an example of the operation mode, the method includes operations S201 to S205 specifically described as follows.

In S201, settings of the saving mode by the pet owner are received through an App on a control terminal.

In the embodiment of the disclosure, the so-called saving mode refers to a power saving or low power consumption operation mode of the pet house. In this mode, the waste of power can be reduced. For example, when the pet is not in the pet house for a period of time, the heating temperature of the pet house by the far infrared instrument can be lowered, etc., so as to reduce the expense for the pet owner. The settings of the saving mode by the pet owner include an assumed duration for which the pet stays still in the pet house or an assumed duration for which the pet is out of the pet house. During the assumed duration, the pet owner can set the heating temperature of the pet house by the far infrared instrument to a lower temperature. It should be noted that, in the embodiment of the disclosure, the saving mode can be set on the premise that the current operation mode of the pet house is a comfort mode, that is to say, only when the operation mode of the pet house is set to the comfort mode, the saving mode can be further set as the operation mode of the pet house. Herein, the comfort mode refers to a mode that when various devices in the pet house are running, the environmental parameters such as light intensity, temperature, humidity, noise and smell in the pet house are comfortable for a pet in the pet house.

In S202, an audio and video device detects a current daily behavior of the pet.

In an embodiment, the audio and video device includes a motion sensor provided on a far infrared instrument. The motion sensor can capture the current daily behavior (such as movement, or rest in static state) of the pet in pet house at any time. The audio and video device, such as the motion sensor, can be connected with other computing devices in the pet house, such as a timer.

In S203, if the audio and video device detects a static behavior of the pet, a timer counts a duration of the static behavior of the pet, and returns a counting result to the data center.

As mentioned above, the motion sensor in the pet house is connected to the timer in the pet house, and the timer is connected to the data center. Therefore, if the motion sensor detects the static behavior of the pet, the timer can count the duration of the static behavior of the pet and return the counting result to the data center.

It should be noted that the motion sensor can not only capture the daily behavior such as the static state of the pet in its house, but also capture the movement behavior of the pet. Therefore, if the audio and video device detects the movement behavior of the pet, for example, the pet changes from a static state to a moving state, the audio and video device will transmit the detection result back to the data center in the same processing mode as when the static behavior of the pet is detected.

In S204, if a duration of the static behavior of the pet is within an earliest time period S of a preset duration range, the data center triggers the saving mode.

In the embodiment of the disclosure, the preset duration range is one of the multiple parameters set by the pet owner for the saving mode in the preceding embodiment, for example, the assumed duration for which the pet stays still in the pet house. Further, the preset duration range can be divided into several time periods, i.e. the preset duration range={period 1, period 2, . . . , period n}, each of which is less than or equal to the preset duration range. When the duration of the static behavior of the pet is within the earliest time period S of the preset duration range, the data center triggers the saving mode. For example, the preset duration range is 2.5 hours, which is divided into five time periods, namely 2.5={0.5, 1, 1.5, 2, 2.5}, the earliest time period S of the preset duration range is 0.5 hour, and if the duration of the static behavior of the pet is 20 minutes, the data center triggers the saving mode because the duration of the static behavior of the pet is within the earliest period S of the preset duration range.

In S205, the far infrared instrument related to the saving mode controls the pet house to a temperature corresponding to the earliest time period S according to a temperature adjustment strategy corresponding to the saving mode.

As mentioned above, the trigger manner for the data center to trigger the operation mode is that the control instruction is transmitted by the data center to the computing device related to the operation mode by using the network, and the control instruction is a part of the control strategy. After the far infrared instrument related to the saving mode receives the control instruction transmitted by the data center, the far infrared instrument related to the saving mode controls the pet house to the temperature corresponding to the earliest time period S according to the temperature adjustment strategy corresponding to the saving mode, for example, lowering the heating temperature of the far infrared instrument for the pet house. Similar to controlling, by the far infrared instrument, the pet house to the temperature corresponding to the earliest time period S, as the duration of the static behavior of the pet is within another time period S′ of the preset duration range, the far infrared instrument controls the pet house to a temperature corresponding to the another time period S′, and this temperature is a temperature lower than the temperature corresponding to the earliest time period S. Taking the preset time range of the embodiment as an example, which is 2.5 hours and divided into five periods, i.e. 2.5={0.5, 1, 1.5, 2, 2.5}, after the far infrared instrument related to the saving mode receives the control instruction transmitted by the data center, the far infrared instrument controls the pet house to the temperature corresponding to the earliest time period S (i.e., 0.5 hour) according to the temperature adjustment strategy corresponding to the saving mode, for example, lowering the heating temperature of the far infrared instrument for the pet house to 25° C. As the duration for which the pet stays at the pet house increases, for example, the pet stays at the pet house for 1 hour, then after the far infrared instrument related to the saving mode receives the control instruction transmitted by the data center, the far infrared instrument related to the saving mode controls the pet house to the temperature corresponding to the time period (i.e., 1 hour) according to the temperature adjustment strategy corresponding to the saving mode, for example, lowering the heating temperature of the far infrared instrument for the pet house to 20° C.

Similar to the case where the audio and video device transmits the detection result to the data center if the audio and video device detects the movement behavior of the pet, in the embodiment of the disclosure, after or when the audio and video device transmits the detection result to the data center if the audio and video device detects the movement behavior of the pet, the operation of performing, by the computing device related to the operation mode Pconfi, real-time control of the pet house according to the control strategy corresponding to the operation mode Pconfi further includes: recovering, by the far infrared instrument related to the saving mode, the pet house to a comfort temperature from the temperature corresponding to the earliest time period S or the another time period S′ according to the temperature adjustment strategy corresponding to the saving mode. Herein, the comfort temperature is a temperature of the pet house when the operation mode of the pet house is the comfort mode.

Because when the pet stays still in the pet house, the temperature required by the pet is not very high; moreover, the longer the time for which the pet stays still in the pet house, the less temperature it needs. Therefore, the far infrared instrument controls the pet house to the temperature corresponding to the earliest time period S or the temperature corresponding to the another time period S′ according to the temperature adjustment strategy corresponding to the saving mode, for example, lowering the temperature, which can save the expense spent by the pet owner.

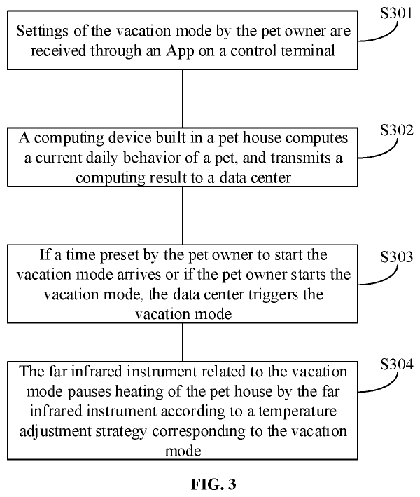

Referring to FIG. 3, which is a schematic flowchart of a pet house control method when a vacation mode is taken as an example of the operation mode, the method includes operations S301 to S304 specifically described as follows.

In S301, settings of the vacation mode by the pet owner are received through an App on a control terminal.

In the embodiment of the disclosure, the vacation mode refers to a mode for a case where the pet owner may travel with the pet when he is on vacation. In this case, the pet house is in an unused state where various devices built in the pet house should be in a low power consumption state or a closed state. The settings of the vacation mode by the pet owner may be information such as a start time of the vacation and a vacation duration set by the pet owner.

In S302, a computing device built in a pet house computes a current daily behavior of a pet, and transmits a computing result to a data center.

In the vacation mode, the current daily behavior of the pet may be no behavior, that is, the audio and video device built in the pet house cannot detect any sound, image or video about the pet.

In S303, if a time preset by the pet owner to start the vacation mode arrives or if the pet owner starts the vacation mode, the data center triggers the vacation mode.

In S304, the far infrared instrument related to the vacation mode pauses heating of the pet house by the far infrared instrument according to a temperature adjustment strategy corresponding to the vacation mode.

In the embodiment of the disclosure, the duration in which heating of the pet house by the far infrared instrument is paused can be equivalent to the vacation duration set by the pet owner, and can also be determined by the data center according to the computing result returned by computing device such as an audio and video device. For example, if the vacation duration set by the pet owner elapses, but the audio and video device built in the pet house still cannot detect the pet in the pet house, the data center transmits a control instruction to stop heating of the far infrared instrument, and the far infrared instrument continues stopping heating of the pet house according to the control instruction.

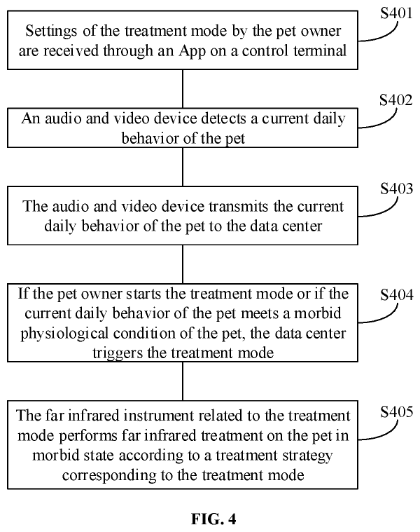

Referring to FIG. 4, which is a schematic flowchart of a pet house control method when a treatment mode is taken as an example of the operation mode, the method includes operations S401 to S405 specifically described as follows.

In S401, settings of the treatment mode by the pet owner are received through an App on a control terminal.

In the embodiment of the disclosure, the so-called treatment mode refers to an operation mode of the pet house triggered by the data center when the current daily behavior of the pet meets a morbid physiological condition of the pet. In this mode, the computing device in the pet house, such as the far infrared instrument, starts to perform far infrared treatment on the sick pet. Settings of the treatment mode by the pet owner includes setting various parameters when the far infrared instrument starts to perform far infrared treatment on the sick pet through the App of the control terminal, such as how long the treatment lasts in total, the treatment frequency and the duration of each treatment, and the like.

In S402, an audio and video device detects a current daily behavior of the pet.

In this embodiment, The current daily behavior of the pet can be the vigorous pace of the pet when walking, a duration of exercise in a period of time, a duration of staying still, the number and frequency of meals, the frequency of heartbeat, the facial expression, the length, weight and subtlety of breathing, or the like. These daily behaviors can reflect the health of the pet. For example, if the pet walks without strength, stays still for too long or eats abnormally less, the pet may be sick.

In S403, the audio and video device transmits the current daily behavior of the pet to the data center.

The current daily behavior of the pet transmitted to the data center, such as the vigorous pace of the pet when walking, the duration of exercise in a period of time, the duration of staying still, the number and frequency of meals, the frequency of heartbeat, facial expressions, and the length, weight and subtlety of breathing.

In S404, if the pet owner starts the treatment mode or if the current daily behavior of the pet meets a morbid physiological condition of the pet, the data center triggers the treatment mode.

As mentioned above, the audio and video device built into the pet house is a tool for a pet owner to interact with his/her pet, and pet owner can observe the current daily behavior of the pet through the audio and video device. When the pet owner observes the current daily behavior of the pet through audio and video, and confirms that the pet is sick, he/she can directly start the treatment mode. Therefore, if the pet owner starts the treatment mode or if the current daily behavior of the pet meets the morbid physiological condition of the pet, the data center triggers the treatment mode. Herein, whether the current daily behavior of the pet meets the morbid physiological condition of the pet can be determined by the data center according to the historical daily behavior of the pet combined with animal medical knowledge.

In S405, the far infrared instrument related to the treatment mode performs far infrared treatment on the pet in morbid state according to a treatment strategy corresponding to the treatment mode.

In the embodiment of the disclosure, performing far infrared treatment on the pet in morbid state may be triggering the far infrared instrument to perform rehabilitation therapy on the pet in morbid state. The far infrared instrument is a kind of treatment device which uses low-intensity laser to irradiate the skin, acupoints and other animal body parts to eliminate inflammation, relieve pain and promote healing of sick animals. The far infrared instrument has therapeutic effects because cells respond to it. When laser is applied to cells (i.e., photobiological stimulation), “communication” will be enhanced between cells. The light quantum transmitted by laser penetrates several centimeters under the skin, and mitochondria in skin cells will absorb the red light of laser, which will lead to the increase of adenosine triphosphate (ATP), which means that cells are healthier. In addition, the photobiological stimulation can also trigger some cell functions, such as promoting healing, promoting collagen production, promoting enzyme production and increasing cell growth. With the increase of collagen level, the number of damaged skin cells decreases, which helps prevent scar tissue formation. In addition to stimulating cell growth, low-intensity laser irradiation can also relieve pain and eliminate inflammation, which can reduce tissue swelling. Laser can also improve the activity of red blood cells, increase their oxygen carrying capacity, and quickly remove lipid substances on surfaces of the red blood cells. When the far infrared instrument is triggered to perform rehabilitation therapy on the pet in morbid state, the parameters such as working wavelength, power and modulation frequency of the far infrared instrument can be set to adapt to the current pathological state of the pet, thus providing the best treatment and rehabilitation scheme. The parameters such as working wavelength, power (or intensity) and modulation frequency of the far infrared instrument are not set once and for all, but are changed at any time with the change of the rehabilitation and comfort of the pet, which reflects the intelligent characteristics of the control.

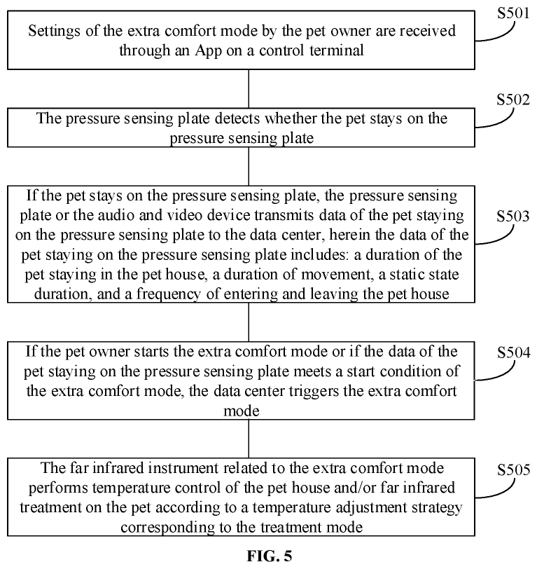

Referring to FIG. 5, which is a schematic flowchart of a pet house control method when an extra comfort mode is taken as an example of the operation mode, the far infrared instrument is further configured with an infrared heating mat having a pressure sensing plate. The pet house control method shown in FIG. 5 includes operations S501 to S505 specifically described as follows.

In S501, settings of the extra comfort mode by the pet owner are received through an App on a control terminal.

In S502, the pressure sensing plate detects whether the pet stays on the pressure sensing plate.

In the embodiment of the disclosure, the pressure sensing plate is a flat plate with a built-in pressure sensor. The infrared heating mat can be arranged at the bottom of the pet house as the bottom plate of the pet house. When the pet enters the pet house, the pressure sensor built in the pressure sensing plate of the infrared heating mat detects the pressure, thus it is determined that the pet stays in the pet house at this moment.

In S503, if the pet stays on the pressure sensing plate, the pressure sensing plate or the audio and video device transmits data of the pet staying on the pressure sensing plate to the data center, herein the data of the pet staying on the pressure sensing plate includes: a duration of the pet staying in the pet house, a duration of movement, a static state duration, and a frequency of entering and leaving the pet house.

It should be noted that, in the embodiment of that disclosure, the pressure sensing plate can detect whether the pet enters the pet house. As mentioned above, the audio and video device can also detect whether the pet enters the pet house and detect its daily behavior in the pet house. The pressure sensing plate can be connected with the far infrared instrument through the USB port of the far infrared instrument. Therefore, if the pet stays on the pressure sensing plate, the pressure sensing plate and/or the audio and video device transmit the data of the pet staying on the pressure sensing plate back to the data center through the far infrared instrument. Herein, the data of the pet staying on the pressure sensing plate includes the duration of the pet staying in the pet house, the duration of movement, the static state duration, and the frequency of entering and leaving the pet house.

In S504, if the pet owner starts the extra comfort mode or if the data of the pet staying on the pressure sensing plate meets a start condition of the extra comfort mode, the data center triggers the extra comfort mode.

As mentioned above, the pet owner can observe whether the pet enters the pet house or stays in pet houses, and can observe its daily behavior in pet house through the audio and video device, so as to determine whether to start the extra comfort mode of the pet house; the pet owner can start the extra comfort mode of the pet house through the App of the control terminal, and this start operation can be transmitted to the data center through the network. Therefore, if the pet owner starts the extra comfort mode or if the data of the pet staying on the pressure sensing plate meets the start condition of the extra comfort mode, the data center triggers the extra comfort mode.

In S505, the far infrared instrument related to the extra comfort mode performs temperature control of the pet house and/or far infrared treatment on the pet according to a temperature adjustment strategy corresponding to the treatment mode.

In the embodiment of that disclosure, the far infrared instrument related to the extra comfort mode performs temperature control of the pet house and/or far infrared treatment on the pet according to the temperature adjustment strategy corresponding to the treatment mode in a way similar to the temperature control of the pet house and/or the far infrared treatment on the pet performed by the far infrared instrument according to the temperature adjustment strategy corresponding to any other mode in the any preceding embodiment, and detailed description will not be repeated herein.

Compared with the computing devices such as the audio and video device, the pressure sensing plate can detect the daily behavior of the pet more accurately, such as the precise time when the pet lies in the pet house. Therefore, in the extra mode, the control strategy given by the data center is more accurate, and therefore it can help pet owners save money more than in other operation modes, such as the saving mode.

It should be noted that when the operation mode of the pet house is the extra mode, the data center can draw data curves indicating the daily behavior of the pet staying in the pet house according to the data of the pet staying on the pressure sensing plate, and the data center will return these data curves to the App on the control terminal for display. After the pet owner checks these data curves in the App on the control terminal, the operation modes of the pet house can be customized according to these data curves, for example, setting when is the best time to heat and heat pet houses in 24 hours a day, and setting when is the best time to apply far infrared treatment on the pet and setting the best duration of the treatment, and so on.

The data center is described hereinafter. In the embodiment of the disclosure, the data center acquires data of daily behaviors of pets through the App on the control terminal or the computing device built in the pet house. According to the acquired data of daily behaviors, a data model is established to generate control strategies for real-time control of the pet house corresponding to various operation modes. Theoretically, according to the data of the daily behavior of the pet, combined with deep learning algorithms such as machine learning, the data center can learn the control strategies implemented by a pet owners to a pet house or the control strategies for real-time control of the pet house corresponding to various operation modes.

Finally, through the control terminal and the built-in audio and video device of the pet house, the information between the pet and the pet owner is exchanged. For example, through the audio device, the pet owner can call the pet or play a piece of music for the pet, or through the video device, the pet owner can interact with the pet or play a video for the pet, etc.

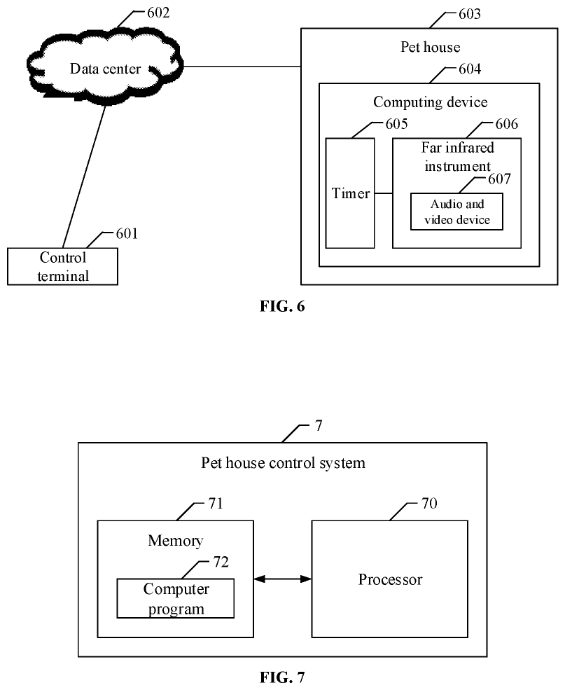

Referring to FIG. 6, it is a schematic structural diagram of a pet house control system provided by an embodiment of the disclosure. For convenience of description, only parts related to the disclosure are shown. The pet house control system illustrated in FIG. 6 mainly includes a control terminal 601, a data center 602 and a pet house 603, herein the pet house 603 has a built-in computing device 604 including a timer 605 and a far infrared instrument 606, the far infrared instrument 606 is provided with an audio and video device 607 and at least one USB port (not shown in the figure), and the audio and video device 607 includes a motion sensor. Detailed description is made below.

The control terminal 601 is configured to receive, through an Application (App) on the control terminal 601, settings of multiple operation modes of the pet house 603, the settings being set by a pet owner.

The computing device 604 is configured to compute a current daily behavior of the pet, and transmit a computing result to the data center 602.

The data center 602 is configured to trigger an operation mode Pconfi of the multiple operation modes if a condition set by the pet owner or the current daily behavior of the pet meets a trigger condition for the operation mode Pconfi.

The computing device 604 related to the operation mode Pconfi is configured to perform real-time control of the pet house 603 according to a control strategy corresponding to the operation mode Pconfi.

It should be noted that, the pet house control system provided by the embodiment of the disclosure is based on the same idea as the method embodiment of the disclosure, each entity being used for implementing the steps of the method embodiment, and has the corresponding technical features with the method embodiment; and the technical effect brought by the system embodiment of the disclosure is the same as that brought by the method embodiment of the disclosure. For specific contents, reference can be made to the description in the method embodiment of the disclosure, which will not be repeated herein.

The disclosure further provides a pet house including a pet house body and a computing device in the pet house control method of any example of FIG. 1 to FIG. 5, which is controlled using the pet house control method of any example of FIG. 1 to FIG. 5. In addition, the pet house also includes necessary devices for pets to eat and live, such as an electronic feeder, a food holding device, a temperature adjusting device, a lighting device, a dehumidifier, and a humidifier.

FIG. 6 is a schematic structural diagram of a pet house control system provided by an embodiment of the disclosure. As shown in FIG. 7, the pet house control system 7 of the embodiment mainly includes a processor 70, a memory 71, and a computer program 72 stored in the memory 71 and executable on the processor 70, such as a program of a pet house control method. The processor 70 performs the operations in the above-described embodiments of the pet house control method, such as the operations shown in any of the examples of FIG. 1 to FIG. 5 when the computer program 72 is executed. Alternatively, when the processor 70 executes the computer program 72, the functions of the modules/units in the above-described system embodiments, such as the functions of the control terminal 601, the data center 602 and the computing device 604 built into the pet house 603 shown in FIG. 6, are implemented.

Exemplarily, the computer program of the method includes: receiving, through an Application (App) on the control terminal, settings of multiple operation modes of the pet house, the settings being set by a pet owner; computing, by a computing device built in the pet house, a current daily behavior of a pet, and transmitting a computing result back to the data center, wherein the computing device includes a timer and a far infrared instrument, wherein the far infrared instrument is provided with an audio and video device and at least one Universal Serial Bus (USB) port, and the audio and video device includes a motion sensor; triggering, by the data center, an operation mode Pconfi of the multiple operation modes if a condition set by the pet owner or the current daily behavior of the pet meets a trigger condition for the operation mode Pconfi; and performing, by the computing device related to the operation mode Pconfi, real-time control of the pet house according to a control strategy corresponding to the operation mode Pconfi. The computer program 72 may be divided into one or more modules/units which are stored in memory 71 and executed by processor 70 to implement the disclosure. One or more modules/units may be a series of computer program instruction segments capable of performing a particular function, which instruction segments are used to describe the execution of the computer program 72 in the pet house control system 7. For example, the computer program 72 can be divided into functions of the control terminal 601, the data center 602 and the computing device 604 (modules of the virtual device), and the specific functions of the various modules are as follows. The control terminal 601 is configured to receive, through an Application (App) on the control terminal 601, settings of multiple operation modes of the pet house 603, the settings being set by a pet owner; the computing device 604 is configured to compute a current daily behavior of the pet, and transmit a computing result to the data center 602; the data center 602 is configured to trigger an operation mode Pconfi of the multiple operation modes if a condition set by the pet owner or the current daily behavior of the pet meets a trigger condition for the operation mode Pconfi; and the computing device 604 related to the operation mode Pconfi is configured to perform real-time control of the pet house 603 according to a control strategy corresponding to the operation mode Pconfi.

The pet house control system 7 may include, but not limited to, the processor 70 and the memory 71. Persons skilled in the art can understand that FIG. 7 is only an example of the pet house control system 7 and does not constitute a limitation on the pet house control system 7, and may include more or fewer components than the illustration, or combine certain components or different components. For example, the control terminal may further include input and output devices, network access devices, buses, and so on.

The processor 70 may be a Central Processing Unit (CPU), or other general processors, Digital Signal Processor (DSP), Application Specific Integrated Circuit (ASIC), Field-Programmable Gate Array (FPGA) or other programmable logic device, discrete gate or transistor logic device, discrete hardware components, etc. The general processor may be a microprocessor or any conventional processor.

The memory 71 may be an internal storage unit of the pet house control system 7, such as a hard disk or a memory. It may also be an external storage device of the pet house control system 7, such as a plug-in hard disk equipped on the system, Smart Media Card (SMC), Secure Digital (SD) Card, Flash Card, etc. Further, the memory 71 may also include both the internal storage unit of the pet house control system 7 and the external storage device. The memory 71 is used to store computer programs and other programs and data required to the control terminal. It may also be used to temporarily store data that has been output or will be output.

The persons skilled in the art can clearly understand that, for convenience and conciseness of description, only the above-mentioned division of each functional unit and module is used as an example for illustration. In practical applications, the above-mentioned functions may be allocated by different functional units or modules. That is, the internal structure of the device is divided into different functional units or modules to complete all or part of the functions described above. The functional units and modules in the embodiments may be integrated into one processing unit, or each unit may exist alone physically, or two or more units may be integrated into one unit. The above integrated units may use hardware or software functional units to implement. In addition, the specific names of each functional unit and module are only for the purpose of distinguishing each other, and are not used to limit the protection scope of the disclosure. For the specific working processes of the units and modules in the above system, please refer to the corresponding processes in the foregoing method embodiments, which will not be repeated here.

The above embodiments have different focus in the description. For parts that are not disclosed in detail regarding a certain embodiment, please refer to relevant descriptions in other embodiments.

The person skilled in the art may realize that, the units and algorithm steps of the examples described in conjunction with the embodiments disclosed herein can be implemented by electronic hardware, or a combination of computer software and electronic hardware. Whether these functions are executed in hardware or software, it depends on the specific application of the technical solution and design constraints. Professional technicians can use different methods to implement the described functions for each specific application, but such implementation should not be considered as go beyond the protection scope of the present disclosure.

In the embodiments provided by this invention, it should be understood that the disclosed device/control terminal and method may be implemented in other manners. For example, the above described device/control terminal embodiments are only for illustration. That is to say, the module or unit division is only a logical function division. There are other division ways in actual realization. For instance, several units or components can be combined or be integrated into another system, or some features can be neglected or will not be executed. Another point is that, the shown or discussed mutual coupling or direct coupling or communication link can be indirect coupling or communication link connected by interface, device or unit, which can be electrical, mechanical, etc.

The units illustrated as separate modules can be physically separate or not, and components shown as units can be a physical unit nor not, which can either be located at one place or be distributed on several network units. Part or all units can be selected therein according to actual needs to realize the purpose of the embodiment solution.

In addition, functional units in various embodiments of this invention can be integrated into one processing unit, or exist physically and separately, or be integrated into one for every two units or above. The above integrated units can be realized either through hardware or software functional units.

The integrated modules/units can be stored in the readable storage medium of a computer if the integrated units are realized through the software functional module and sold or used as an independent product. Based on this understanding, all or part of the operations of the methods according to the above embodiments can be performed by related hardware instructed by the computer program. The computer program of the pet house control method can be stored in a computer readable storage medium, and when executed by a processor, the computer program can implement operations of the various method embodiments, which include: receiving, through an Application (App) on the control terminal, settings of multiple operation modes of the pet house, the settings being set by a pet owner; computing, by a computing device built in the pet house, a current daily behavior of a pet, and transmitting a computing result back to the data center, wherein the computing device includes a timer and a far infrared instrument, wherein the far infrared instrument is provided with an audio and video device and at least one Universal Serial Bus (USB) port, and the audio and video device includes a motion sensor; triggering, by the data center, an operation mode Pconfi of the multiple operation modes if a condition set by the pet owner or the current daily behavior of the pet meets a trigger condition for the operation mode Pconfi; and performing, by the computing device related to the operation mode Pconfi, real-time control of the pet house according to a control strategy corresponding to the operation mode Pconfi. The computer program includes computer program code, of which may be in the form of source code, object code, executable file, or some intermediate form. The computer-readable medium may include: any entity or device capable of carrying computer program code, recording medium, U disk, removable hard disk, diskette, optical disc, computer memory, Read-Only Memory (ROM), Random Access Memory (RAM), electrical carrier signal, telecommunications signal and software distribution medium, etc. It should be noted that the content contained in the computer-readable medium can be appropriately increased or decreased according to the requirements of legislation and patent practice in jurisdictions. For example, in certain jurisdictions, according to legislation and patent practice, computer-readable medium does not include electrical carrier signal or telecommunications signal. The above embodiments are only used to describe the technical solution of this invention, instead of limiting the protection scope; though detailed descriptions of the invention are provided in reference to the embodiments mentioned above, persons skilled in the art should understand that: they still can modify the technical solutions provided by embodiments mentioned above, or make equivalent replacements of part technical features; however, these modifications or replacements do not deviate the essence of corresponding technical solutions from the spirit and scope of this invention embodiment, and should be included in the protection scope of this invention.

1. A pet house control method, applied to a pet house control system comprising a pet house, a control terminal and a data center, the method comprising:
receiving, through an Application (App) on the control terminal, settings of multiple operation modes of the pet house, the settings being set by a pet owner;
computing, by a computing device built in the pet house, a current daily behavior of a pet, and transmitting a computing result back to the data center, wherein the computing device comprises a timer and a far infrared instrument, wherein the far infrared instrument is provided with an audio and video device and at least one Universal Serial Bus (USB) port, and the audio and video device comprises a motion sensor;
triggering, by the data center, an operation mode Pconfi of the multiple operation modes if a condition set by the pet owner or the current daily behavior of the pet meets a trigger condition for the operation mode Pconfi; and
performing, by the computing device related to the operation mode Pconfi, real-time control of the pet house according to a control strategy corresponding to the operation mode Pconfi.

2. The pet house control method according to claim 1, wherein the multiple operation modes comprise a saving mode, and computing, by the computing device built in the pet house, the current daily behavior of the pet and transmitting the computing result back to the data center comprises:
detecting, by the audio and video device, the current daily behavior of the pet; and
if the audio and video device detects a static behavior of the pet, counting, by the timer, a duration of the static behavior of the pet and returning a counting result to the data center,
wherein triggering, by the data center, the operation mode Pconfi of the multiple operation modes if the condition set by the pet owner or the current daily behavior of the pet meets the trigger condition for the operation mode Pconfi comprises: if the duration of the static behavior of the pet is within an earliest time period S of a preset duration range, triggering, by the data center, the saving mode; and
wherein performing, by the computing device related to the operation mode Pconfi, real-time control of the pet house according to the control strategy corresponding to the operation mode Pconfi comprises: controlling, by the far infrared instrument related to the saving mode, the pet house to a temperature corresponding to the earliest time period S according to a temperature adjustment strategy corresponding to the saving mode.

3. The pet house control method according to claim 2, further comprising:
as the duration of the static behavior of the pet is within another time period S′ of the preset duration range, controlling, by the far infrared instrument, the pet house to a temperature corresponding to the another time period S′.

4. The pet house control method according to claim 2, wherein computing, by the computing device built in the pet house, the current daily behavior of the pet and transmitting the computing result back to the data center further comprises: if the audio and video device detects a motion behavior of the pet, transmitting, by the audio and video device, a detection result back to the data center; and wherein performing, by the computing device related to the operation mode Pconfi, real-time control of the pet house according to the control strategy corresponding to the operation mode Pconfi further comprises: recovering, by the far infrared instrument related to the saving mode, the pet house to a comfort temperature from the temperature corresponding to the earliest time period S or the another time period S′ according to the temperature adjustment strategy corresponding to the saving mode.

5. The pet house control method according to claim 1, wherein the multiple operation modes comprise a vacation mode, and triggering, by the data center, the operation mode Pconfi of the multiple operation modes if the condition set by the pet owner or the current daily behavior of the pet meets the trigger condition for the operation mode Pconfi comprises: if a time preset by the pet owner to start the vacation mode arrives or if the pet owner starts the vacation mode, triggering, by the data center, the vacation mode; and wherein performing, by the computing device related to the operation mode Pconfi, real-time control of the pet house according to the control strategy corresponding to the operation mode Pconfi comprises: pausing, by the far infrared instrument related to the vacation mode, heating of the pet house by the far infrared instrument according to a temperature adjustment strategy corresponding to the vacation mode.

6. The pet house control method according to claim 1, wherein the multiple operation modes comprise a treatment mode, and computing, by the computing device built in the pet house, the current daily behavior of the pet and transmitting the computing result back to the data center comprises:
detecting, by the audio and video device, the current daily behavior of the pet; and
transmitting, by the audio and video device, the current daily behavior of the pet to the data center,
wherein triggering, by the data center, the operation mode Pconfi of the multiple operation modes if the condition set by the pet owner or the current daily behavior of the pet meets the trigger condition for the operation mode Pconfi comprises: if the pet owner starts the treatment mode or if the current daily behavior of the pet meets a morbid physiological condition of the pet, triggering, by the data center, the treatment mode; and
wherein performing, by the computing device related to the operation mode Pconfi, real-time control of the pet house according to the control strategy corresponding to the operation mode Pconfi comprises: performing, by the far infrared instrument related to the treatment mode, far infrared treatment on the pet in morbid state according to a treatment strategy corresponding to the treatment mode.

7. The pet house control method according to claim 1, wherein the multiple operation modes comprise an extra comfort mode, and the infrared heater is further provided with a pressure sensing plate; and computing, by the computing device built in the pet house, the current daily behavior of the pet and transmitting the computing result back to the data center comprises:
detecting, by the pressure sensing plate, whether the pet stays on the pressure sensing plate; and
if the pet stays on the pressure sensing plate, transmitting, by the pressure sensing plate or the audio and video device, data of the pet staying on the pressure sensing plate to the data center, wherein the data of the pet staying on the pressure sensing plate comprises: a duration of the pet staying in the pet house, a duration of movement, a static state duration, and a frequency of entering and leaving the pet house,
wherein triggering, by the data center, the operation mode Pconfi of the multiple operation modes if the condition set by the pet owner or the current daily behavior of the pet meets the trigger condition for the operation mode Pconfi comprises: if the pet owner starts the extra comfort mode or if the data of the pet staying on the pressure sensing plate meets a start condition of the extra comfort mode, triggering, by the data center, the extra comfort mode; and
wherein performing, by the computing device related to the operation mode Pconfi, real-time control of the pet house according to the control strategy corresponding to the operation mode Pconfi comprises: performing, by the far infrared instrument related to the extra comfort mode, temperature control of the pet house and/or far infrared treatment on the pet according to a temperature adjustment strategy corresponding to the treatment mode.

8. The pet house control method according to claim 7, further comprising:
drawing, by the data center according to the data of the pet staying on the pressure sensing plate, a data curve indicating the daily behavior of the pet staying in the pet house; and
transmitting, by the data center, the data curve back to the App on the control terminal for display.

9. The pet house control method according to claim 1, further comprising:
acquiring, by the data center, data of the daily behavior of the pet through the App on the control terminal or the computing device; and
generating control strategies for real-time control of the pet house corresponding to the multiple operation modes by establishing a data model according to acquired data of the daily behavior.

10. The pet house control method according to claim 1, further comprising:
performing information interaction between the pet and the pet owner through the control terminal and the audio and video device.

11. A pet house control system, comprising: a pet house, a control terminal, and a data center, wherein the pet house has a built-in computing device including a timer and a far infrared instrument, the far infrared instrument is provided with an audio and video device and at least one Universal Serial Bus (USB) port, and the audio and video device includes a motion sensor, and
wherein the control terminal is configured to receive, through an Application (App) on the control terminal, settings of multiple operation modes of the pet house, the settings being set by a pet owner;
the computing device is configured to compute a current daily behavior of the pet, and transmit a computing result to the data center;
the data center is configured to trigger an operation mode Pconfi of the multiple operation modes if a condition set by the pet owner or the current daily behavior of the pet meets a trigger condition for the operation mode Pconfi; and
the computing device related to the operation mode Pconfi is configured to perform real-time control of the pet house according to a control strategy corresponding to the operation mode Pconfi.

12. The pet house control system of claim 11, comprising a memory, a processor, and computer-executable instructions stored in the memory.

13. A non-transitory computer-readable storage medium having stored thereon computer-executable instructions that, when executed by a processor, cause the processor to perform operations of:
receiving, through an Application (App) on a control terminal, settings of multiple operation modes of a pet house, the settings being set by a pet owner;
computing, by a computing device built in the pet house, a current daily behavior of a pet, and transmitting a computing result back to a data center, wherein the computing device comprises a timer and a far infrared instrument, wherein the far infrared instrument is provided with an audio and video device and at least one Universal Serial Bus (USB) port, and the audio and video device comprises a motion sensor;
triggering, by the data center, an operation mode Pconfi of the multiple operation modes if a condition set by the pet owner or the current daily behavior of the pet meets a trigger condition for the operation mode Pconfi; and
performing, by the computing device related to the operation mode Pconfi, real-time control of the pet house according to a control strategy corresponding to the operation mode Pconfi.

14. A pet house, comprising a pet house body and the computing device of the pet control system according to claim 11, wherein the pet house is controlled using a control method which comprises:
receiving, through the APP on the control terminal, settings of multiple operation modes of the pet house, the settings being set by the pet owner;
computing, by the computing device, a current daily behavior of a pet, and transmitting a computing result back to the data center, wherein the computing device comprises a timer and a far infrared instrument, wherein the far infrared instrument is provided with an audio and video device and at least one Universal Serial Bus (USB) port, and the audio and video device comprises a motion sensor;
triggering, by the data center, an operation mode Pconfi of the multiple operation modes if a condition set by the pet owner or the current daily behavior of the pet meets a trigger condition for the operation mode Pconfi; and
performing, by the computing device related to the operation mode Pconfi, real-time control of the pet house according to a control strategy corresponding to the operation mode Pconfi.

15. The non-transitory computer-readable storage medium according to claim 13, wherein the multiple operation modes comprise a saving mode, and computing, by the computing device built in the pet house, the current daily behavior of the pet and transmitting the computing result back to the data center comprises:
detecting, by the audio and video device, the current daily behavior of the pet; and
if the audio and video device detects a static behavior of the pet, counting, by the timer, a duration of the static behavior of the pet and returning a counting result to the data center,
wherein triggering, by the data center, the operation mode Pconfi of the multiple operation modes if the condition set by the pet owner or the current daily behavior of the pet meets the trigger condition for the operation mode Pconfi comprises: if the duration of the static behavior of the pet is within an earliest time period S of a preset duration range, triggering, by the data center, the saving mode; and
wherein performing, by the computing device related to the operation mode Pconfi, real-time control of the pet house according to the control strategy corresponding to the operation mode Pconfi comprises: controlling, by the far infrared instrument related to the saving mode, the pet house to a temperature corresponding to the earliest time period S according to a temperature adjustment strategy corresponding to the saving mode.

16. The non-transitory computer-readable storage medium according to claim 15, wherein the processor is caused to perform a further operation of:
as the duration of the static behavior of the pet is within another time period S′ of the preset duration range, controlling, by the far infrared instrument, the pet house to a temperature corresponding to the another time period S′.

17. The non-transitory computer-readable storage medium according to claim 15, wherein computing, by the computing device built in the pet house, the current daily behavior of the pet and transmitting the computing result back to the data center further comprises: if the audio and video device detects a motion behavior of the pet, transmitting, by the audio and video device, a detection result back to the data center; and
wherein performing, by the computing device related to the operation mode Pconfi, real-time control of the pet house according to the control strategy corresponding to the operation mode Pconfi further comprises: recovering, by the far infrared instrument related to the saving mode, the pet house to a comfort temperature from the temperature corresponding to the earliest time period S or the another time period S′ according to the temperature adjustment strategy corresponding to the saving mode.

18. The non-transitory computer-readable storage medium according to claim 13, wherein the multiple operation modes comprise a vacation mode, and triggering, by the data center, the operation mode Pconfi of the multiple operation modes if the condition set by the pet owner or the current daily behavior of the pet meets the trigger condition for the operation mode Pconfi comprises: if a time preset by the pet owner to start the vacation mode arrives or if the pet owner starts the vacation mode, triggering, by the data center, the vacation mode; and
wherein performing, by the computing device related to the operation mode Pconfi, real-time control of the pet house according to the control strategy corresponding to the operation mode Pconfi comprises: pausing, by the far infrared instrument related to the vacation mode, heating of the pet house by the far infrared instrument according to a temperature adjustment strategy corresponding to the vacation mode.

19. The non-transitory computer-readable storage medium according to claim 13, wherein the multiple operation modes comprise a treatment mode, and computing, by the computing device built in the pet house, the current daily behavior of the pet and transmitting the computing result back to the data center comprises:
detecting, by the audio and video device, the current daily behavior of the pet; and
transmitting, by the audio and video device, the current daily behavior of the pet to the data center,
wherein triggering, by the data center, the operation mode Pconfi of the multiple operation modes if the condition set by the pet owner or the current daily behavior of the pet meets the trigger condition for the operation mode Pconfi comprises: if the pet owner starts the treatment mode or if the current daily behavior of the pet meets a morbid physiological condition of the pet, triggering, by the data center, the treatment mode; and
wherein performing, by the computing device related to the operation mode Pconfi, real-time control of the pet house according to the control strategy corresponding to the operation mode Pconfi comprises: performing, by the far infrared instrument related to the treatment mode, far infrared treatment on the pet in morbid state according to a treatment strategy corresponding to the treatment mode.

20. The non-transitory computer-readable storage medium according to claim 13, wherein the multiple operation modes comprise an extra comfort mode, and the infrared heater is further provided with a pressure sensing plate; and computing, by the computing device built in the pet house, the current daily behavior of the pet and transmitting the computing result back to the data center comprises:
detecting, by the pressure sensing plate, whether the pet stays on the pressure sensing plate; and
if the pet stays on the pressure sensing plate, transmitting, by the pressure sensing plate or the audio and video device, data of the pet staying on the pressure sensing plate to the data center, wherein the data of the pet staying on the pressure sensing plate comprises: a duration of the pet staying in the pet house, a duration of movement, a static state duration, and a frequency of entering and leaving the pet house,
wherein triggering, by the data center, the operation mode Pconfi of the multiple operation modes if the condition set by the pet owner or the current daily behavior of the pet meets the trigger condition for the operation mode Pconfi comprises: if the pet owner starts the extra comfort mode or if the data of the pet staying on the pressure sensing plate meets a start condition of the extra comfort mode, triggering, by the data center, the extra comfort mode; and
wherein performing, by the computing device related to the operation mode Pconfi, real-time control of the pet house according to the control strategy corresponding to the operation mode Pconfi comprises: performing, by the far infrared instrument related to the extra comfort mode, temperature control of the pet house and/or far infrared treatment on the pet according to a temperature adjustment strategy corresponding to the treatment mode.
